(19) United States
(12) Patent Application Publication
(10) Pub. No.: US 2013/0135269 A1
(43) Pub. Date: May 30, 2013

(54) TWO STATE THREE ELECTRODE DRIVE SCHEME

(71) Applicant: William J. Cummings, Clinton, WA (US)

(72) Inventor: William J. Cummings, Clinton, WA (US)

(73) Assignee: QUALCOMM MEMS Technologies, Inc., San Diego, CA (US)

(21) Appl. No.: 13/307,979

(22) Filed: Nov. 30, 2011

(51) Int. Cl. G06F 3/038

(52) U.S. Cl. 345/208; 345/212

(57) ABSTRACT

This disclosure provides systems, methods and apparatus, including computer programs encoded on computer storage media, for driving electromechanical display devices that suffer from adhesion forces. In one aspect, a method for driving a display element is provided that includes applying a first series of voltages to a first electrode and applying a second series of voltages from a set of voltage levels to a second electrode to selectively place a movable layer into an actuated state or un-actuated state based on a voltage difference between the first and second electrodes. The method further includes applying a third series of voltages levels from the set of voltage levels to a third electrode. The third series of voltage levels are applied to the third electrode such that a non-zero voltage exists between the third and second electrodes during a release time period where a desired state is the un-actuated state.

### TECHNICAL FIELD

This disclosure relates to a drive scheme for driving electromechanical display devices that suffer from adhesion forces.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method for driving a display element in an array of display elements. The method includes applying a first series of voltages to a first electrode of the display element. The method further includes applying a second series of voltages from a set of voltage levels to a second electrode of the display element to selectively place a movable layer of the display element into an actuated state corresponding to a first position or an un-actuated state corresponding to a second position based on a voltage difference between the first electrode and the second electrode. The method further includes applying a third series of voltages levels using voltage levels from the set of voltage levels to a third electrode of the display element. The second electrode is between the first electrode and the third electrode. The third series of voltage levels are applied to the third electrode such that a non-zero voltage exists between the third electrode and the second electrode during a release time period in which a desired state of the display element is the un-actuated state.

Another innovative aspect of the subject matter described in this disclosure can be implemented in an apparatus for driving a display device. The apparatus includes a display element included in an array of display elements. The display element includes a first electrode. The display element further includes a second electrode. The display element further includes a third electrode. The second electrode is located between the first electrode and the third electrode. The display element further includes a movable layer configured to be in an actuated state in a first position or an un-actuated state in a second position based on a voltage difference between the first electrode and the second electrode. The apparatus further includes a driver circuit configured to apply a first series of voltage levels to the first electrode. The driver circuit is further configured to apply a second series of voltage levels from a set of voltage levels to the second electrode. The first series and second series of voltages levels are applied to selectively place the display element into the actuated or the un-actuated state. The driver circuit is further configured to apply a third series of voltages levels using voltage levels from the set of voltage levels to the third electrode of the display element. The third series of voltage levels are applied to the third electrode such that a non-zero voltage exists between the second electrode and the third electrode during a release time period in which a desired state of the display element is the un-actuated state.

Yet another innovative aspect of the subject matter described in this disclosure can be implemented in an apparatus for driving a means for displaying in an array of means for displaying. The apparatus includes means for applying a first series of voltages to a first means for conducting of the means for displaying. The apparatus further includes means for applying a second series of voltages from a set of voltage levels to a second means for conducting of the means for displaying to selectively place a movable layer of the means for displaying into an actuated state corresponding to a first position or an un-actuated state corresponding to a second position based on a voltage difference between the first means for conducting and the second means for conducting. The apparatus further includes means for applying a third series of voltages levels using voltage levels from the set of voltage levels to a third means for conducting of the means for displaying. The second means for conducting is between the first means for conducting and the third means for conducting. The third series of voltage levels are applied to the third means for conducting such that a non-zero voltage exists between the third means for conducting and the second means for conducting during a release time period in which a desired state of the means for displaying is the un-actuated state.

Another innovative aspect of the subject matter described in this disclosure can be implemented in a computer program product. The computer program product includes a computer-readable medium. The computer-readable medium includes code for applying a first series of voltages to a first electrode of a display element. The computer-readable medium further includes code for applying a second series of voltages from a set of voltage levels to a second electrode of the display element to selectively place a movable layer of the display element into an actuated state corresponding to a first position or an un-actuated state corresponding to a second position based on a voltage difference between the first electrode and the second electrode. The computer-readable medium further includes code for applying a third series of voltages levels using voltage levels from the set of voltage levels to a third electrode of the display element. The second electrode is between the first electrode and the third electrode. The third series of voltage levels are applied to the third electrode such that a non-zero voltage exists between the third electrode and the second electrode during a release time period in which a desired state of the display element is the un-actuated state.

Another innovative aspect of the subject matter described in this disclosure can be implemented in a method for driving a display element in an array of display elements. The method includes simultaneously applying a first waveform to a first movable electrode extending along a line of display elements and to a pull up electrode extending along a different line of display elements. The method further includes applying a second waveform to a second movable electrode extending along the different line of display elements to selectively place portions of a movable layer of the different line into either a first position or a second position based on a voltage difference between a fixed electrode and the second movable electrode.

Another innovative aspect of the subject matter described in this disclosure can be implemented in an apparatus for driving a display device. The apparatus includes a driver circuit. The apparatus further includes a line of display elements in an array of display elements. The line of display elements includes a first movable electrode extending along the line of display elements. The line of display elements further includes a pull up electrode extending along the line of display elements. The pull up electrode and a second movable electrode of a different line of display elements in the array of display elements are coupled to a common output of the driver circuit. The pull up electrode may be directly electrically connected to the second movable electrode of the different line of display elements in the array of display elements such that the same waveform is simultaneously applied to the pull up electrode and to the second movable electrode of the different line of display elements.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 is an example of a side cross-sectional view of an interferometric modulator in the actuated or driven state including an additional electrode.

FIG. 10 shows an example of driver circuitry that may be used to drive a portion of an array of display elements that includes third electrodes extending along the same pixel line as each respective second electrode.

FIG. 11 is a diagram showing an example of voltage waveforms that may be applied to electrodes of an interferometric modulator such as the interferometric modulator of FIG. 9.

FIG. 12 is a diagram showing an example of the pull voltage between the second and third electrodes of an interferometric modulator based on the waveforms applied in FIG. 11.

FIG. 13 is a diagram showing another example of voltage waveforms that may be applied to electrodes of an interferometric modulator such as the interferometric modulator of FIG. 9.

FIG. 14 is a diagram showing an example of the pull voltage between the second and third electrodes of an interferometric modulator based on the waveforms applied in FIG. 13.

FIG. 15 is a flowchart of an example of a method of applying voltage levels to an array of interferometric modulators.

FIG. 16 shows an example of driver circuitry for driving a portion of an array of display elements where driver outputs may be coupled to a second electrode of a first row and a third electrode of a second row.

FIG. 17 is a diagram showing an example of voltage waveforms that may be applied to electrodes shown in FIG. 16.

FIG. 18 is a diagram showing an example of the pull voltage between the second and third electrodes of an interferometric modulator based on the waveforms applied in FIG. 17.

FIG. 19 is a flowchart of another example of a method of applying voltage levels to an array of interferometric modulators.

FIG. 20 is a flowchart of another example of a method of applying voltage levels to an array of interferometric modulators.

FIGS. 21A and 21B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Some implementations of an electromechanical display element may include a movable element, such as a mirror or a deformable mechanical layer, which moves between a first position in which the movable element is in contact with a portion of the display element and a second position in which the movable element is not in contact with the portion of the display element. While in the first position, an adhesion force (e.g., stiction) may be generated between the movable element and the contact portion. Accordingly, it may be advantageous to provide display devices and methods of operation in which the adhesion force may be at least partially reduced or counteracted while the movable element is in the first position. In certain implementations, the display device includes one or more electrodes configured to at least partially reduce or counteract the adhesion force on the movable element. Voltages may be applied to the one or more electrodes to provide an electrostatic force that at least partially counteracts the adhesion force.

In one implementation, the one or more electrodes configured to counteract the adhesion force may be driven using the functionality provided to selectively move the display element between the first and second position. The electrodes may be configured to provide a pull up force that can both speed up the transition from first to second positions as well as ensure this movement for pixels where the adhesion force exceeds a restoring force. For example, voltage levels corresponding to the voltage levels used to drive the movable element may be applied to the one or more electrodes to cause a non-zero voltage to be applied for counteracting an adhesion force during a display refresh. During other periods for writing display data, voltage levels corresponding to the voltage levels used to drive the movable layer may be applied to the one or more electrodes to substantially eliminate any extra electrostatic force. In another implementation, the one or more electrodes configured to counteract the adhesion force may be electrically connected to an electrode used to drive the movable elements extending along another line of display elements to create a non-zero voltage applied for counteracting an adhesion force.

Particular implementations of the subject matter described in this disclosure can be implemented to realize one or more of the following potential advantages. By taking advantage of functionality used to write display data to display elements, additional driver circuitry needed to drive the pull up electrodes may be simplified or eliminated. The use of pull up electrodes can increase the speed of a release period and also increase the lifetime of the MEMS device. Implementations described herein may reduce the cost and complexity of providing pull up electrodes for enhancing release performance.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

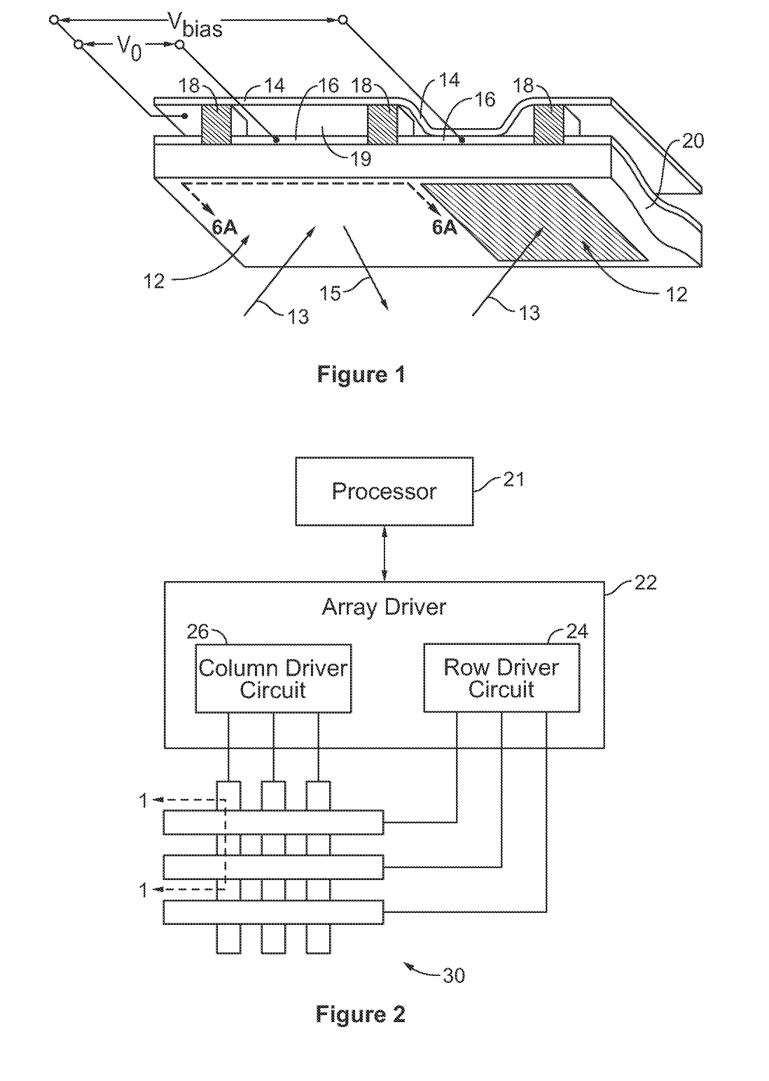

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

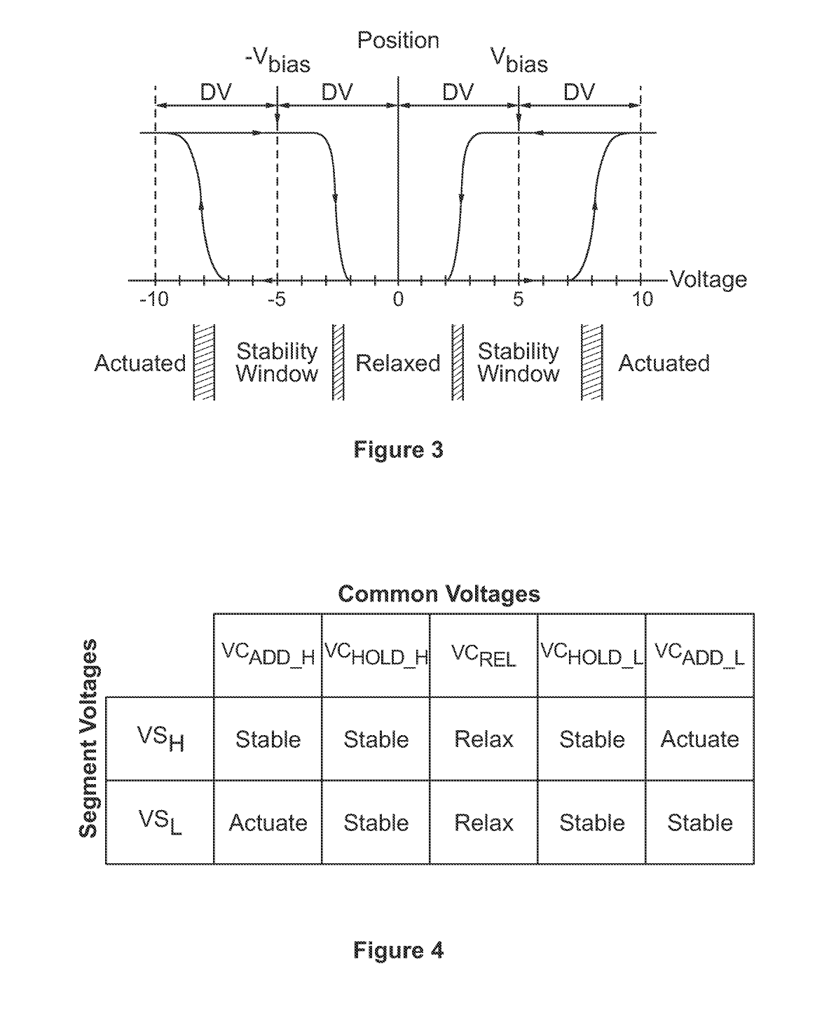

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

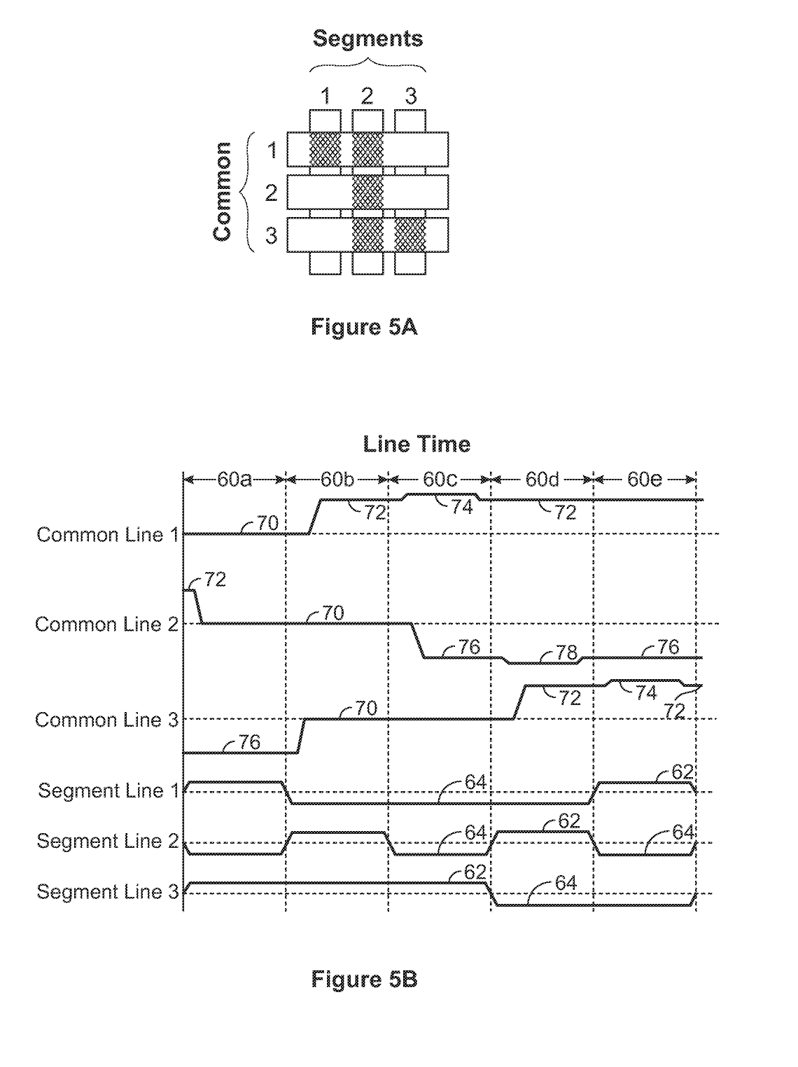

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

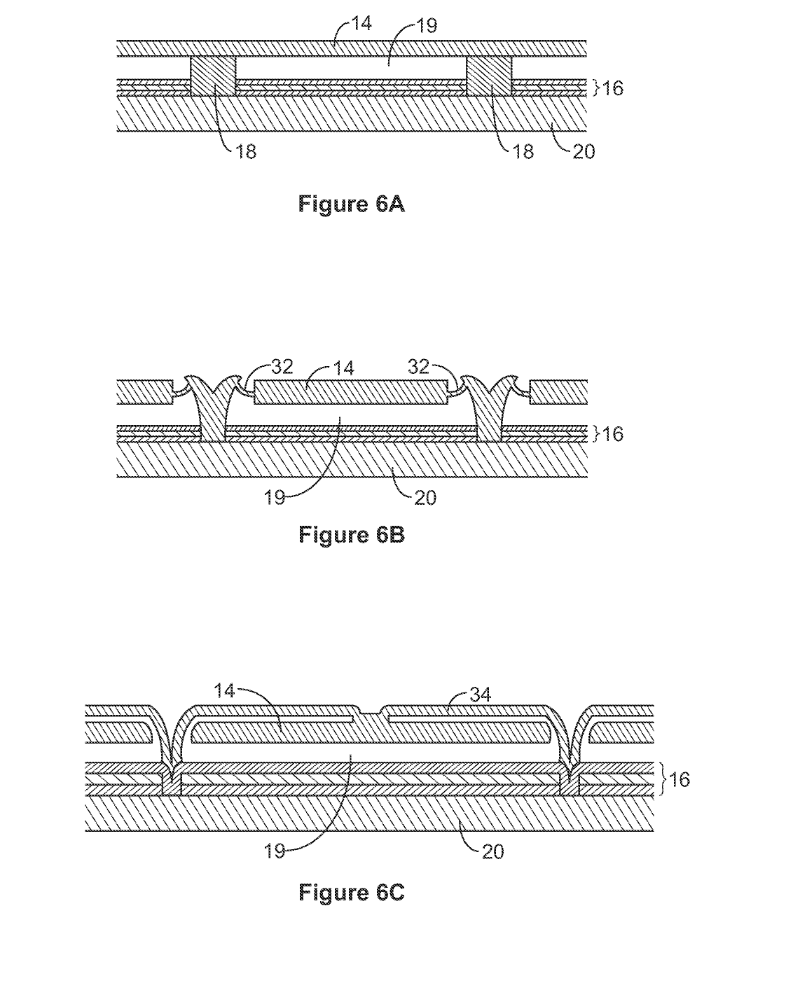

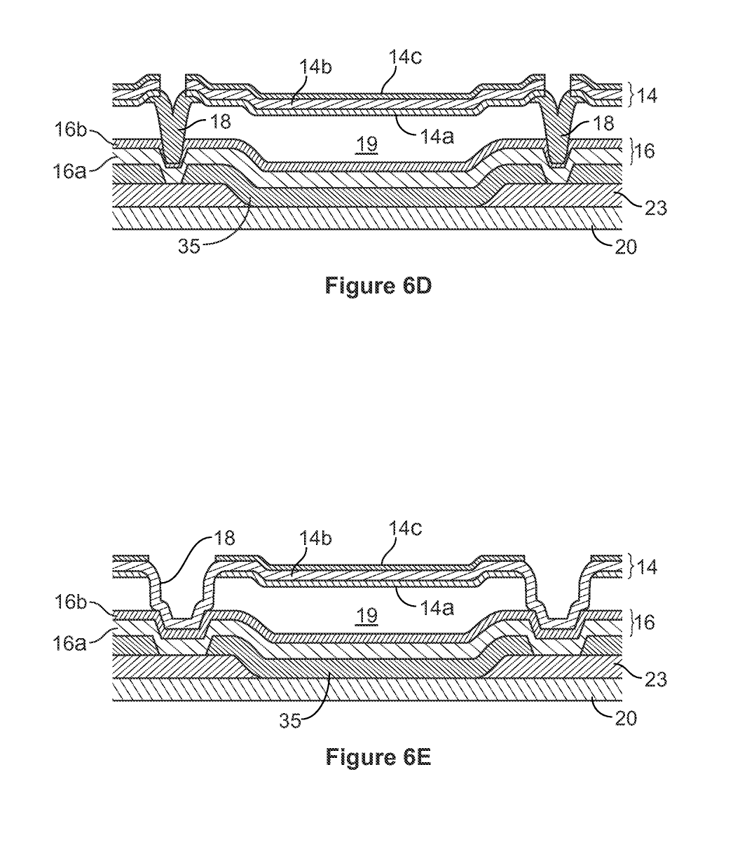

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

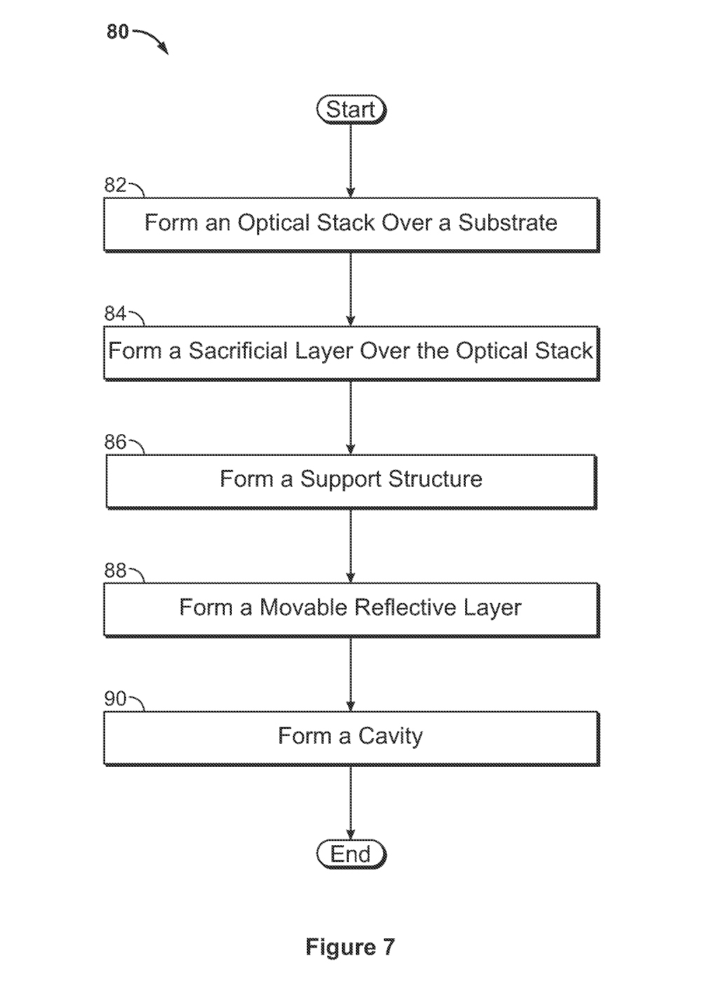

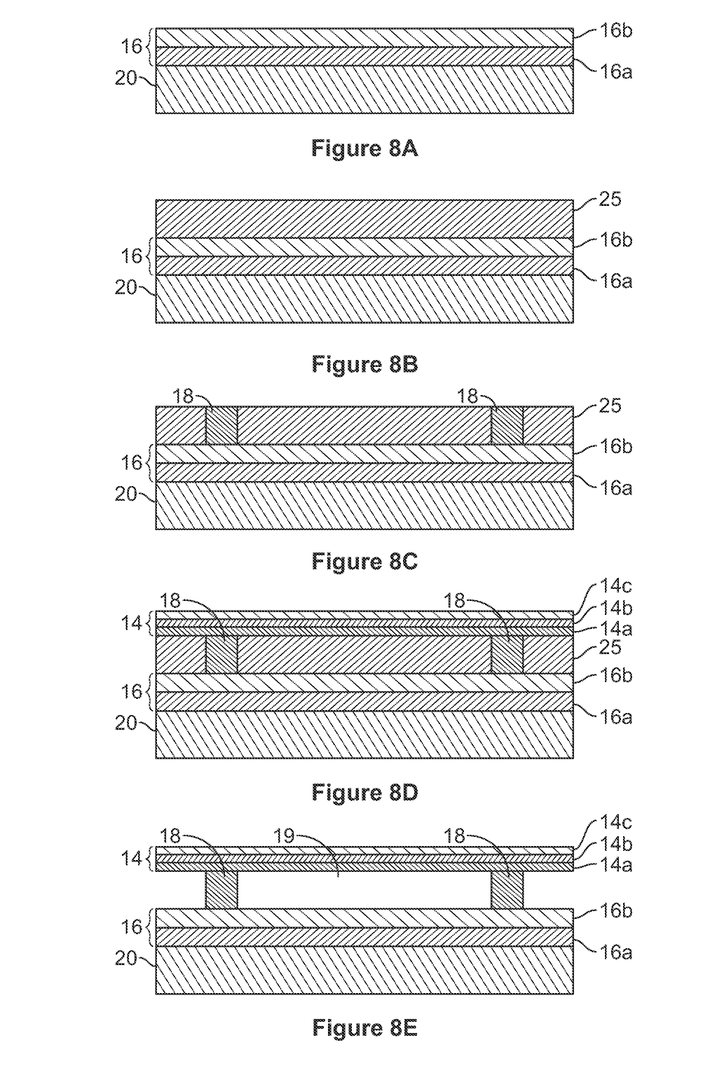

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

When a movable reflective layer 14 is in the actuated position, it may come in contact with a portion of the optical stack 16 of the IMOD 12. An adhesion force may be generated between the movable reflective layer 107 and the portion of the optical stack 16. The adhesion force tends to adhere the deformed portion of the movable reflective layer 14 to a portion of the optical stack 16 of the IMOD 12.

The adhesion force may be caused by forces such as, for example, capillary, electrostatic, or van der Waals forces, or other intermolecular forces. The adhesion force may depend on a range of factors including, for example, the materials used, the shape, orientation, and configuration of structures in the IMOD 12, the roughness of the contact surfaces, and ambient humidity and pressure. The adhesion force may depend on the manner in which the structures within the IMOD 12 are operated, for example, through impulsive motions involving large accelerations or through more gentle quasi-static motions. This adhesion force can increase the time it takes for the reflective layer 14 to release from an actuated position and in extreme cases (where the adhesion force exceeds the restoring force), the reflective layer 14 may not release when the electrostatic attractive force is removed leading to a condition that may be referred to as “stiction.”. “Stiction” is a commonly used term that may include some of the adhesion effects discussed herein.

The process of actuating and de-actuating the IMOD 12 is described herein with reference to FIG. 3. A voltage difference may be applied between the movable reflective layer 14 and the optical stack 16. As shown in FIG. 3, as the voltage difference increases above a first threshold value, an electrostatic force causes the movable reflective layer 14 to deform from the un-actuated position (i.e., relaxed state) to the actuated state (i.e., driven state). As the voltage difference is reduced, the IMOD 12 remains in the driven state until the voltage difference drops below a second threshold value. At the second threshold, the electrostatic force of attraction between the movable reflective layer 14 and the optical stack 16 becomes smaller than mechanical restoring forces tending to return the movable reflective layer 14 to the relaxed state. Accordingly, as the voltage drops below the second threshold, the movable reflective layer 14 “releases” from the portion with which it was in contact. FIG. 4 shows one implementation of an “actuation protocol” that is used to drive the IMOD 12 through this actuation and release cycle.

The adhesion force may alter the nature of this actuation and release cycle. In some implementations of the IMOD pixel 12, the adhesion force at the contact area 913 of the IMOD 12 may be sufficiently large that adhesion inhibits, or in some cases prevents, the release of the movable reflective layer 14 as the voltage difference drops below the second threshold. Also, when the movable reflective layer 14 is released by reducing or eliminating the voltage difference between the movable layer and the optical stack 16, the only force pulling the movable layer 14 up is a mechanical restoring force. Because no electrical force works to release the movable layer in these implementations, the time taken to release the membrane may be significantly longer than the time used to actuate it. Accordingly, it is advantageous to provide architectures that at least partially reduce or counteract the adhesion force and that speed the release process.

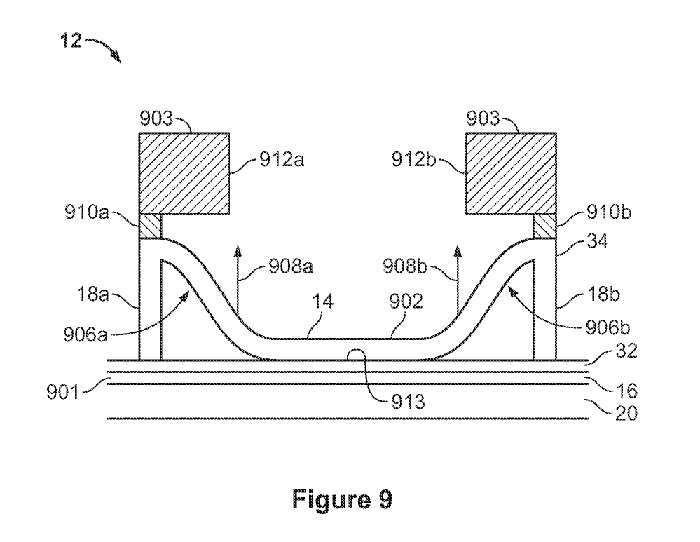

FIG. 9 is an example of a side cross-sectional view of an interferometric modulator 12 in the actuated or driven state including an additional electrode 903. The IMOD display element 12 is fabricated on a substrate layer 20 and includes an optical layer 16, a dielectric layer 32, and a movable reflective layer 14. The substrate layer 20, the optical layer 16, and the dielectric layer 32 have generally the same characteristics and features as the respective layers in the IMOD display element 12 described with reference to FIG. 1. The movable reflective layer 14 includes one or more support posts 18a and 18b and has generally the same characteristics as the movable reflective layer 14 except as specifically stated otherwise.

In the implementation shown in FIG. 9, the movable reflective layer 14 includes a reflective portion, for example, by making at least a portion of the movable reflective layer 14 highly reflective. In this implementation, a first electrode 901 (i.e., fixed electrode) is included in the optical layer 16. The first electrode 901 may correspond to a column electrode extending along a segment line as described above. A support structure 34 includes the movable reflective layer 14 and the support posts 18a and 18b. In some implementations, at least a portion of the movable reflective layer 14 is electrically conductive and includes a second electrode 902 in the IMOD display element 12. The second electrode 902 may correspond to a row electrode extending along a common line as described above. In certain implementations, portions of the support posts 18a and 18b are electrically nonconductive and insulate portions of the movable reflective layer 14 from other portions of the IMOD display element 12 (e.g., the optical layer 16).

The IMOD display element 12 shown in FIG. 9 includes electrodes 912a and 912b that are disposed above the support posts 18a and 18b and that are electrically insulated from other portions of the IMOD display element 12 by electrically nonconductive regions 910a and 910b. In some implementations, the electrically nonconductive regions 910a, 910b include a dielectric material such as, for example, a dielectric film. In the implementation shown in FIG. 9, a third electrode 903 (which may be referred to as a “pull up” electrode or a “release” electrode) includes the electrodes 912a and 912b. The electrodes 912a and 912b in other implementations can have shapes and sizes that are different than shown in FIG. 9. For example, the electrodes 912a and 912b may be relatively short in some implementations. At least a portion of each of the electrodes 912a and 912b may be disposed above at least a portion of the movable reflective layer 14.

FIG. 9 schematically illustrates the IMOD display element 12 when the movable reflective layer 14 is in a first position (the actuated or driven state) in which the movable reflective layer 14 is in contact with a portion 913 of the IMOD display element 12. As further described above, the movable reflective layer 14 can move to a second position (the un-actuated or relaxed state) in which it is not in contact with the portion 913. For example, the movable reflective layer 14 may be fabricated from a mechanically deformable material such as a metal (e.g., aluminum) that can move between the first and second positions. When the IMOD display element 12 is in the driven state, the movable reflective layer 14 is deformed and includes bending regions 906a and 906b, which are disposed between the portion 913 and the support posts 18a and 18b, respectively.

In some implementations of the IMOD display element 12, at least portions of the electrodes 912a and 912b are disposed higher than the movable reflective layer 14 when the movable reflective layer 14 is in the first position and therefore higher than the second electrode 902. In certain implementations, at least a portion of each of the electrodes 912a and 912b protrudes away from the support posts 18a and 18b, respectively, such that these portions are disposed above (e.g., higher than) at least a portion of the movable reflective layer 14 when the movable reflective layer 14 is in the first position (FIG. 9). In certain implementations, the electrodes 912a and 912b are configured so that at least a portion of the electrodes 912a and 912b is disposed directly above at least a portion of the bending regions 906a and 906b, respectively. This configuration and other examples of configurations for the positioning of the electrodes 912a and 912b may be found in U.S. Pat. No. 7,649,671, incorporated herein by reference in its entirety.

In some implementations of the IMOD display element 12, voltages are applied to the electrodes 901, 902, and 903 so that a net electrostatic force on the movable reflective layer 14 at least partially reduces or counteracts the adhesion force on the movable reflective layer 14 in the first position. The voltages may have various ranges of magnitudes and frequencies and may be applied to induce displacements, oscillations, and/or vibrations of the movable reflective layer 14 to assist in moving the movable reflective layer 14 from the first position to the second position. In certain implementations, a voltage difference is applied between the third electrode 903 (e.g., the electrodes 912a, 912b) and the second electrode 902 (e.g., an electrically conductive portion of the movable reflective layer 14). The voltage difference can have various ranges of magnitudes and frequencies and can include one or more relatively short duration impulses. In various implementations, the third electrode 903 is electrically connected to one or more voltage sources by traces or wires that lead off of the display array 30 to the array driver 22 (see FIG. 2). In one implementation, the array driver 22 may use a driver circuit generally similar to the row and column driver circuits 24 and 26 to communicate a suitable electrical signal to the third electrode 903.

The voltage difference applied between the second and third electrodes 902 and 903 causes net electrostatic forces indicated by arrows 908a and 908b to act on the movable reflective layer 14. In certain implementations, portions of the electrodes 912a and 912b protrude directly above at least portions of the bending regions 906a and 906b so that the net electrostatic forces 908a and 908b have reasonably large perpendicular components in the bending regions 906a and 906b that tend to pull the movable reflective layer 14 away from the portion 913. In certain such implementations, the electrostatic forces 908a and 908b may at least partially reduce or counteract the adhesion force and may assist in moving the movable reflective layer 14 from the first position to the second position. Without subscribing to any particular theory, the net electrostatic force 908a applied in the bending region 906a may induce crack opening at an edge of a contact interface between the movable reflective layer 14 and the portion 913. The crack may propagate across the contact interface, assisting the movable reflective layer 14 to peel away from the portion 913 and to move from the first position to the second position. The net electrostatic force 908b applied in the bending region 906b may act in a similar manner, and in certain implementations cracks may open at opposing edges of the contact interface and propagate across the interface. In other implementations different configurations, orientations, and numbers of electrodes (e.g., one) can be used, for example, to initiate crack opening and facilitate release of the movable reflective layer 14.

The magnitudes of the electrostatic forces 764a, 764b at the bending regions 760a, 760b to facilitate release from the driven to the un-driven state typically are much smaller than if the forces were applied to a central region of the reflective element 107. Accordingly, smaller voltage differences (e.g., between the second and third electrodes 902 and 903) can be applied to the IMOD display element 12. Moreover, in some implementations, the electrodes 912a and 912b reduce electrostatic instability and collapse of the movable reflective layer 14 onto the dielectric layer 904, which can be a problem in some closing-gap devices. Further, in certain implementations, voltage impulses having a duration that is shorter than a typical release time of the IMOD display element 12 can be used to facilitate movement of the movable reflective layer 14 from the driven state to the un-driven state.

In some cases, the third electrode 903 may use dedicated driver circuitry and/or power supply circuitry for selectively driving additional voltage levels to the third electrode 903. This additional driver circuitry (e.g., in addition to the driver circuitry such as the row driver circuit 24 and column driver circuit 26 provided to actuate and release an IMOD display element 12) may increase the expense and complexity of the display device. To reduce the need for this additional circuitry, certain aspects of various implementations are directed to driving the third electrode 903 using at least portions of the functionality used to drive the common line and segment lines as described above. The array driver 22 or substantial portions of the array driver 22 may be adapted and used to additionally drive the third electrode 903. In one aspect, the third electrode 903 may be driven without requiring any additional analog voltage levels as compared to the voltage levels used to drive the first and second electrodes 901 and 902 (e.g., the voltage levels described above with reference to FIG. 4). This may significantly reduce the expense and complexity of the display device.

The array driver 22 may apply a series of voltages (i.e., a waveform) to the third electrode 903 to counteract the adhesion force during actuation and release periods when writing lines of display data. As described above, a generated voltage across electrodes 901 and 902 may be referred to herein as the “pixel voltage.” The voltage that is generated between the second electrode 902 and the third electrode 903 to counteract the adhesion force may be referred to herein as the “pull voltage.” Aspects of certain implementations are directed to applying voltage waveforms to the electrodes 901, 902, and 903 to produce a non-zero pull voltage during release periods while also ensuring that the pixel voltage remains substantially unaffected by any pull voltage (i.e., the pull voltage does not work significantly against the ability to actuate an IMOD display element 12) when writing display data to the array 30.

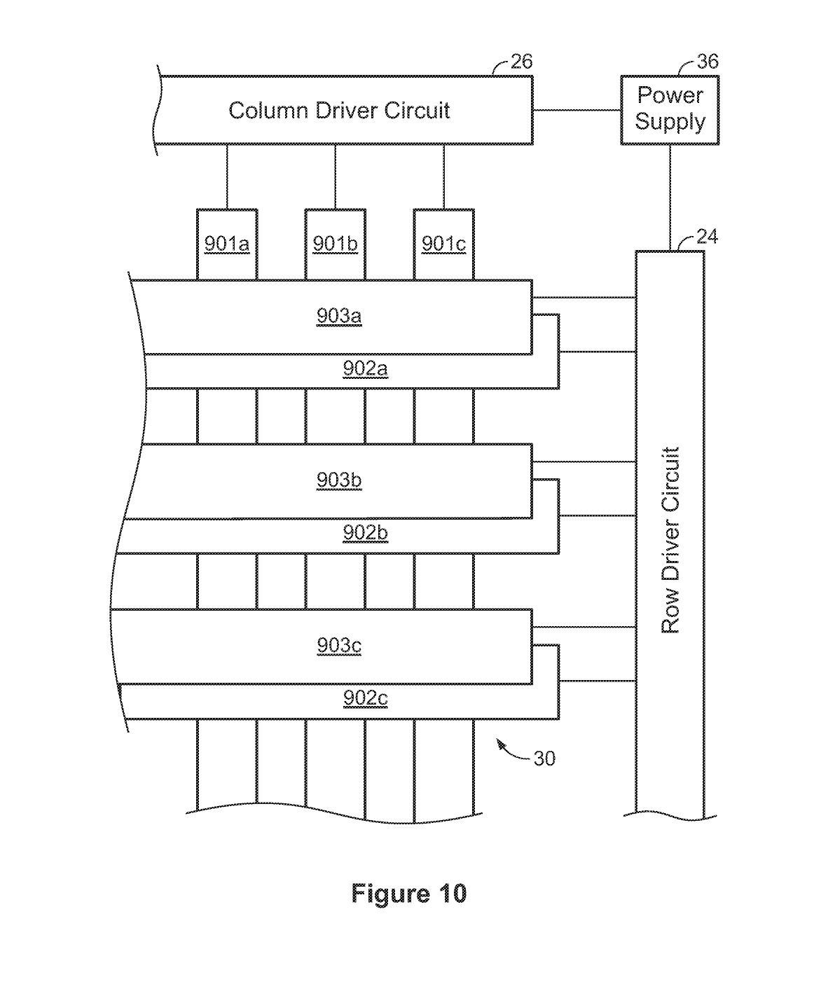

In one aspect, the third electrode 903 may be positioned in a layer that extends along the same pixel line along which the second electrode 902 extends. For example, the third electrode 903 may extend along the pixel line of the movable reflective layer 14 including the second electrode 902. In this way, the row driver circuit 24 may be adapted to drive both the second and third electrodes 902 and 903. FIG. 10 shows an example of driver circuitry that may be used to drive a portion of an array 30 of display elements that includes third electrodes 903a, 903b, and 903c extending along the same pixel line as each respective second electrode 902a, 903b, and 903c. The display elements in the array 30 may each be the display element 12 shown in FIG. 9. The second electrodes 902a, 902b, and 902c and the third electrodes 903a, 903b, and 903c may correspond to the second electrode 902 and third electrode 903 respectively as shown in FIG. 9. Similarly as in FIG. 2, a column driver circuit 26 and a row driver circuit 24 may receive power from a power supply 36 to drive waveforms to the first electrodes 901a, 901b, and 901c and second electrodes 902a, 902b, and 902c respectfully. The row driver circuit 24 may also be electrically connected to and configured to drive a waveform to each of the third electrodes 903a, 903b, and 903c. The power supply may be configured to provide a fixed number of voltage levels to each of the column driver circuit 26 and the row driver circuit 24 for generating desired waveforms. In one aspect, the row driver circuit 24 may be configured to drive the same magnitude of voltage levels to the third electrodes 903a, 903b, and 903c as are being driven to the second electrodes 902a, 902b, and 902c to cause a non-zero pull voltage during a line refresh period while writing display data to the display elements in a line of the array 30.

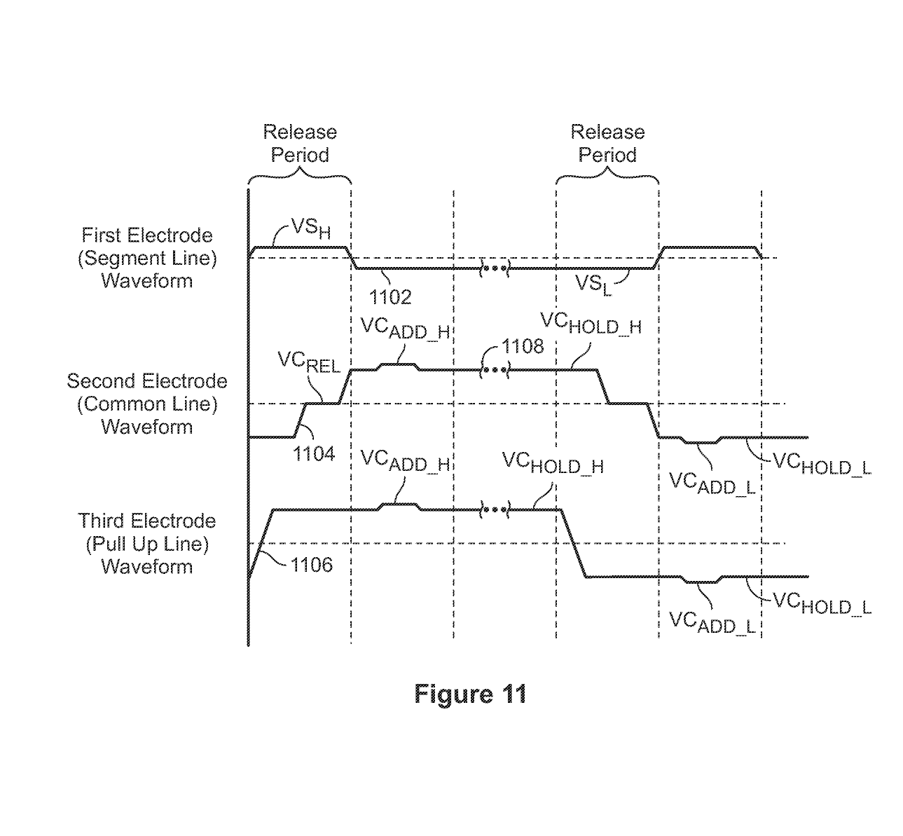

FIG. 11 is a diagram showing an example of voltage waveforms that may be applied to electrodes 901, 902, and 903 of an interferometric modulator 12 such as the interferometric modulator 12 of FIG. 9. In one implementation as described with reference to FIG. 11, substantially the same waveform applied to the second electrode 902 (e.g., a common line) may be applied to the third electrode 903 during all periods except for during a release period. During the release period, the third electrode 903 may be driven with one of the available voltage levels that are normally used to drive the second electrode 902. The voltage applied to the third electrode is chosen such that a non-zero pull voltage is applied to the IMOD display element 12 during the release period. Also shown in FIG. 11 is a voltage waveform 1102 applied to the first electrode 901 which is used to determine whether or not a display element 12 is selected to be actuated as described above with reference to FIG. 5.

More specifically, FIG. 11 shows waveforms 1104 and 1106 for driving the second electrode 902 and the third electrode 903 respectively over two write cycles of alternating polarity. As shown in FIG. 11, a second electrode waveform 1104 voltage may be driven to VC_{REL} (e.g., substantially zero) during a release period. This may happen as the second electrode waveform 1104 voltage applied to the second electrode 902 is driven from either VC_{HOLD}_{_{—}}_{H} or VC_{HOLD}_{_{—}}_{L} to VC_{REL} depending on the current polarity. As described above with reference to FIG. 5B, the resulting pixel voltage when the second electrode waveform 1104 voltage is driven to VC_{REL} may be within the relaxation window regardless of whether the first electrode is at VS_{H} or VS_{L}. Before or during the release period, a third electrode (or pull up) waveform 1106 voltage applied to the third electrode 903 may be driven to one of either VC_{HOLD}_{_{—}}_{H} or VC_{HOLD}_{_{—}}_{L} such that a non-zero pull voltage is applied across the IMOD display element 12. For example, if the second electrode waveform 1104 voltage is at VC_{HOLD}_{_{—}}_{L} before being driven to VC_{REL}, the third electrode waveform 1106 voltage may be driven from VC_{HOLD}_{_{—}}_{L} to VC_{HOLD}_{_{—}}_{H} before the second electrode waveform 1104 voltage is driven to VC_{REL}. Alternatively, if the second electrode waveform 1104 voltage is at VC_{HOLD}_{_{—}}_{H} before being driven to VC_{REL}, then the third electrode waveform 1106 voltage may be driven from VC_{HOLD}_{_{—}}_{H} to VC_{HOLD}_{_{—}}_{L} before the second electrode waveform 1104 voltage is driven to VC_{REL}.

During periods other than the release period, the third electrode may be simultaneously driven with the same voltage levels being applied to second electrode 902 such that the third electrode waveform 1106 may be the same as the second electrode waveform 1104. As the second electrode waveform 1104 and the third electrode waveform 1106 are the same during these periods, substantially zero voltage difference exists between the third electrode 903 and the second electrode 902. In other words, the pull voltage may be maintained at substantially zero outside the release period. The third electrode waveform 1106, outside the release period, may therefore use the same voltage levels used for the second electrode waveform 1104. While some additional driver circuitry may be needed to provide the third electrode waveform 1104, the cost and complexity may be reduced as the same voltage levels used to provide the second electrode waveform 1104 may be used. It should be appreciated that the second electrode 902 may be held at VC_{HOLD}_{_{—}}_{H} (or VC_{HOLD}_{_{—}}_{L}) for a substantial amount of time (shown by the gap in time 1108) after being driven to VC_{ADD} _{_{—}}_{H} (or VC_{ADD} _{_{—}}_{L}) as compared to the period of time between the beginning of the release period and the time at which the second electrode 902 is driven to VC_{ADD} _{_{—}}_{H} (or VC_{ADD} _{_{—}}_{L}). This time period may correspond to the time needed to drive all the other second electrode lines in the array.

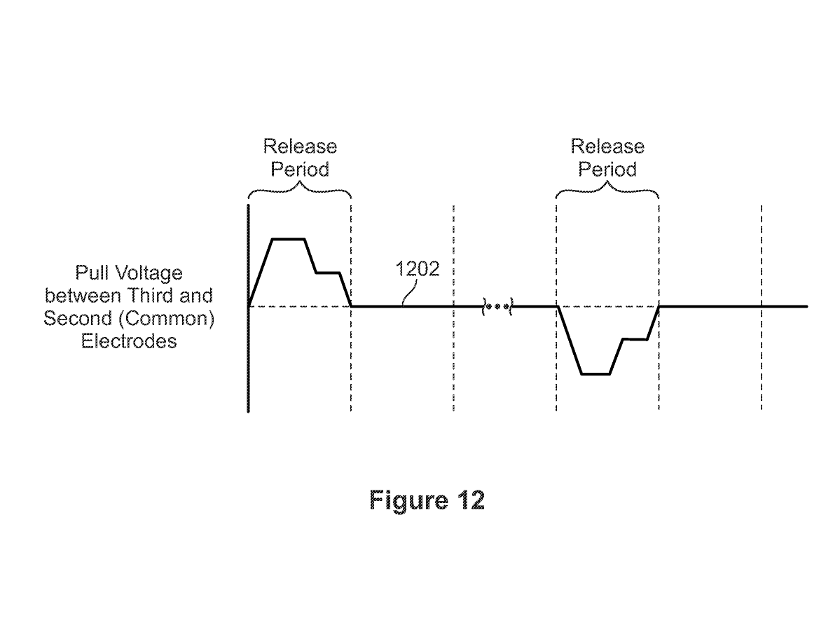

FIG. 12 is a diagram showing an example of the pull voltage between electrodes 902 and 903 of an interferometric modulator 12 based on the waveforms applied in FIG. 11, where the pull voltage 1202 is the voltage of waveform 1106 minus the voltage of waveform 1104. During a first portion of a release period, before the second electrode waveform 1104 voltage is driven to VC_{REL}, the third electrode waveform 1106 voltage may be driven to either VC_{HOLD}_{_{—}}_{H} or VC_{HOLD}_{_{—}}_{L} as described above. The resulting pull voltage 1202 during this time period may therefore correspond substantially to the difference between VC_{HOLD}_{_{—}}_{H} and VC_{HOLD}_{_{—}}_{L}. Once the second electrode waveform 1104 voltage is driven to VC_{REL}, and while the third electrode waveform 1106 voltage is maintained at VC_{HOLD}_{_{—}}_{H} (or VC_{HOLD}_{_{—}}_{L}), the resulting pull voltage 1202 during the second portion of the release period corresponds to the difference between VC_{HOLD}_{_{—}}_{H} (or VC_{HOLD}_{_{—}}_{L}) and VC_{REL}.

During times other than the release period, the pull voltage 1202 is substantially zero as the waveforms 1104 and 1106 applied to both the second electrode 902 and the third electrode 903 are substantially equivalent. As a result, a non-zero pull voltage is applied substantially only during release periods to help to counteract stiction and ensure that any actuated IMOD display element 12 is released. According to this implementation, no other voltage levels are used beyond what is already provided to drive the second electrode 902 for writing display data to each IMOD display element 12.

In other implementations, it may be additionally desirable to further reduce the number of voltage levels used to drive the third electrode 903.

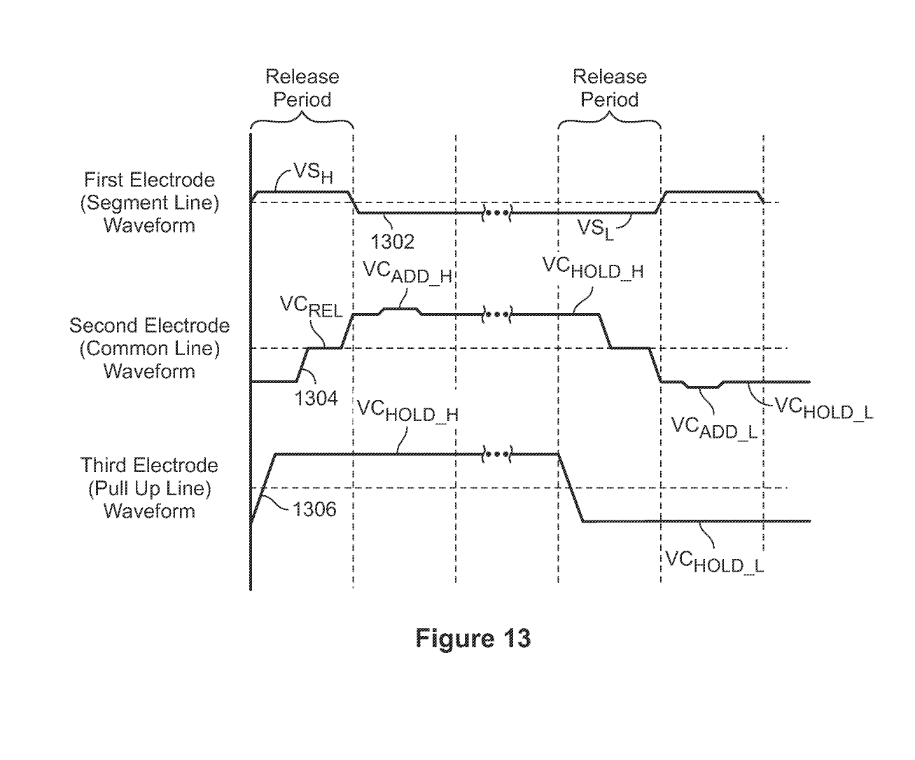

FIG. 13 is a diagram showing another example of voltage waveforms that may be applied to electrodes 901, 902, and 903 of an interferometric modulator 12 such as the interferometric modulator 12 of FIG. 9. In the implementation shown in FIG. 13, the number of different voltage levels applied to the third electrode 903 may be reduced to a smaller subset of the voltage levels used to drive the second electrode 902 as compared to the implementation described with reference to FIGS. 11 and 12. Also shown in FIG. 13 is a voltage waveform 1302 applied to the first electrode 901 which is used to determine whether or not a display element 12 is selected to be actuated. During a release period, the same second electrode waveform 1304 and third electrode waveform 1306 as shown with respect to FIG. 11 may be applied to the second and third electrodes 902 and 903 respectively. As with FIG. 11, this may result in a non-zero pull voltage applied during the release period. During periods outside the release period, rather than drive the third electrode waveform 1306 voltage with VC_{ADD} _{_{—}}_{H} or VC_{ADD}_{_{—}}_{L} at the same time the second electrode waveform 1304 voltage is driven with VC_{ADD} _{_{—}}_{H} or VC_{ADD} _{_{—}}_{L}, the third electrode waveform 1306 voltage may be maintained at either VC_{HOLD} _{_{—}}_{H} or VC_{HOLD}_{_{—}}_{L}. Accordingly, the number of different voltage levels used to drive the third electrode 903 is reduced to two voltage levels. The two voltage levels may correspond to two of the same voltage levels being used to drive the second electrode 902.

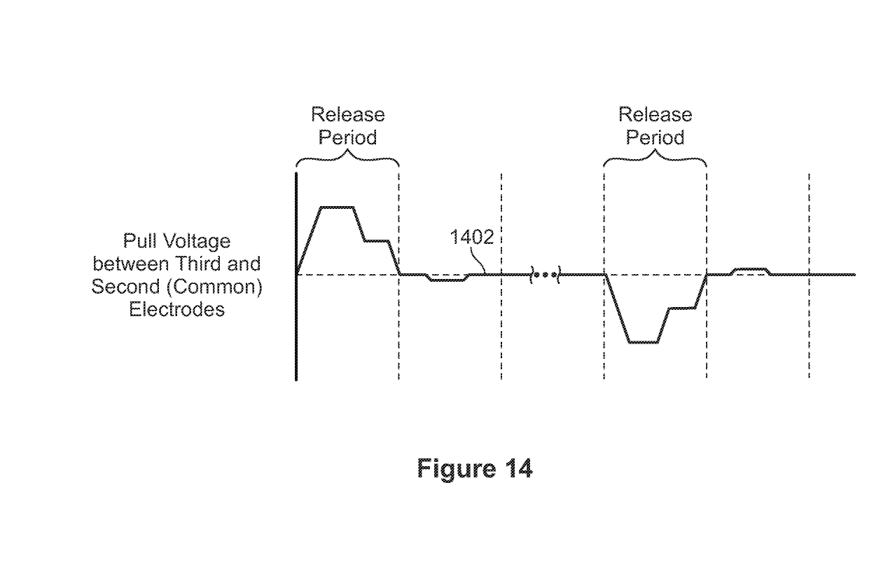

FIG. 14 is a diagram showing an example of the pull voltage 1402 between electrodes 902 and 903 of a display element 12 based on the waveforms applied in FIG. 13. During release periods, a non-zero pull voltage exists between the electrodes 902 and 903 due to the voltage difference resulting from the difference between the third electrode waveform 1306 and the second electrode waveform 1304, similarly as described above with reference to FIG. 12. However, the pull voltage 1402 is also non-zero during portions of other periods corresponding to when the second electrode waveform 1304 voltage is driven to VC_{ADD} _{_{—}}_{H} or VC_{ADD} _{_{—}}_{L} while the third electrode waveform 1306 voltage is maintained at either VC_{HOLD}_{_{—}}_{H} or VC_{HOLD}_{_{—}}_{L}. In this case, the non-zero pull voltage 1402 may potentially cause a small amount of interference with the pixel voltage and could potentially work against actuation of the IMOD display element 12. However, the amount that the pull voltage 1402 works against actuation of the IMOD display element 12 may be small enough so as to not have a substantial effect on actuation (i.e., the total voltage across the IMOD display element 12 is still well within the actuation window). Using the same voltage levels used to drive the second electrode 902 and reducing the number of voltage levels needed to drive the third electrode 903 may further reduce the cost and complexity of the display device.

The actual voltage levels applied to the electrodes 901, 902, and 903 may vary substantially according to the design of the display device. In some implementations, the difference between VC_{ADD} _{_{—}}_{L} and VC_{ADD}_{_{—}}_{H} may be between about 15 and 30 volts. It should further be appreciated that while FIGS. 11 and 13 show examples of different waveforms, the particular timing of the sequence of voltages may vary according to the particular implementation.

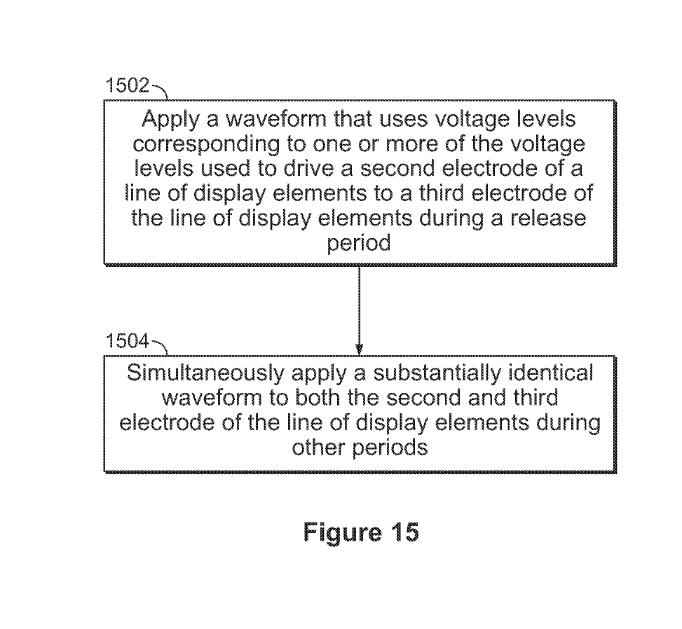

FIG. 15 is a flowchart of an example of a method of applying voltage levels to an array of interferometric modulators. The method of FIG. 15 may be used in conjunction with the implementation described above with reference to FIGS. 11-14. In block 1502, an array driver 22 (e.g., a row driver circuit 24) may apply a waveform that uses voltage levels corresponding to one or more of the voltage levels used to drive a second electrode 902 of a line (e.g., a common line) of display elements to a third electrode 903 of the line of display elements during a release period. The release period may correspond to a clear cycle in which all display elements in a line are placed in an un-actuated state. The particular waveform for driving the third electrode 903 may be chosen such that a non-zero voltage level exists between the second electrode 902 and the third electrode 903 during the release period. The non-zero voltage may help ensure that the movable reflective layer 14 of the display element is released and is not stuck in contact at the interface 913 as shown in FIG. 9.

In block 1504, an array driver 22 may simultaneously apply a substantially identical waveform to both the second electrode 902 and the third electrode 903 of the line of display elements during other periods. The other periods may correspond to a time in which display data is written to display elements for driving them to an actuated state. As a result of the waveforms being substantially the same for each of the second and third electrodes 902 and 903, a substantially zero pull-voltage may be applied during the addressing periods so as not to work against actuation of individual IMOD elements. Substantially identical waveforms may correspond to two waveforms applied to the second and third electrodes 902 and 903 that do not substantially affect actuation or hold states. For example, the waveforms 1304 and 1306 applied during the release period as shown in FIG. 13 may be substantially identical as any resulting pull voltage outside the release period may negligibly affect actuation or hold states.

In some cases, the implementations described above with reference to FIGS. 11-15 may need additional driver circuitry and/or adaptation of the array driver 22 to provide a waveform to the third electrode 903. In another implementation, it may be desirable to further reduce additional driver circuitry for driving the third electrode 903 by using the same driver outputs used to drive the second electrode 902.

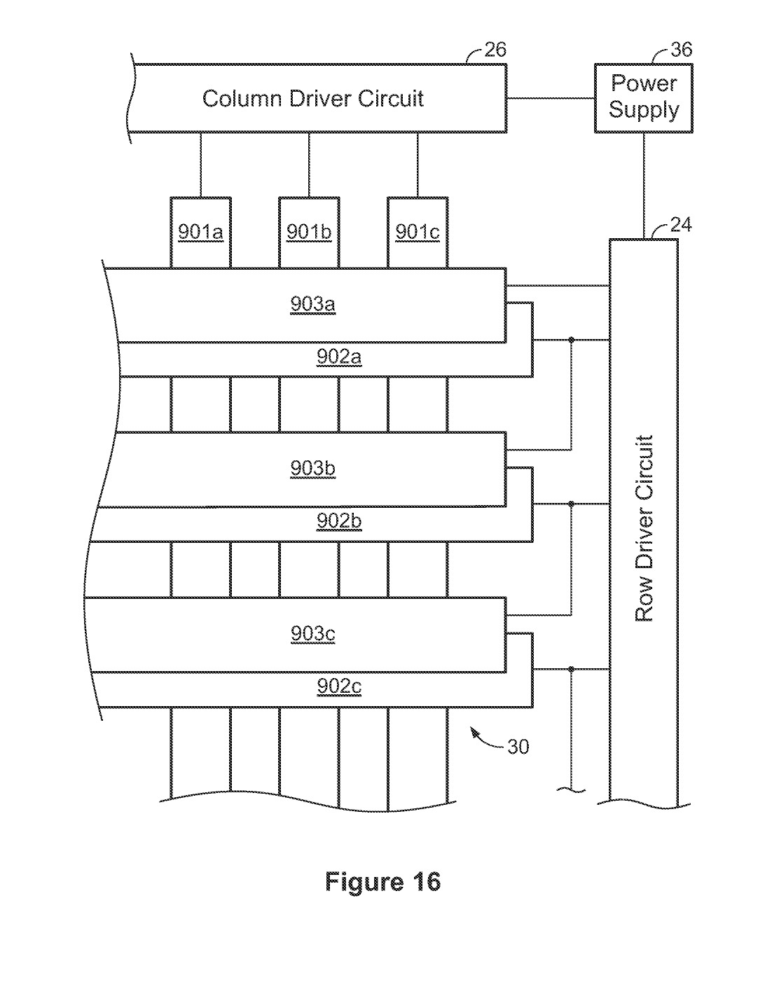

FIG. 16 shows an example of driver circuitry for driving a portion of an array 30 of display elements (e.g., where each display element 12 may be the display element 12 of FIG. 9) where driver outputs may be coupled to a second electrode 902a of a first row and a third electrode 903b of a second row. More specifically, the same driver output from the row driver circuit 24 may be coupled to both the third electrode 903b (i.e., release or “pull up” electrode) of the second line of display elements and a second electrode 902a (i.e., movable electrode) of the first line of display elements. The third electrode 903b of the second line of display elements may be electrically connected (e.g., “hard wired”) to the second electrode 902a of the first line of display elements. This may be repeated for the rest of the lines in the display where the same driver output may be coupled to both the third electrode 903c of the third line of display elements to a second electrode 902b of the first line of display elements and so on. An additional driver output may also be coupled to the third electrode 903a of the first line of display elements to ensure that all third electrodes 903a, 903b, and 903c are driven with appropriate waveforms. As a result, a voltage waveform applied by the driver circuitry to the second electrode 902a will be substantially simultaneously applied to the third electrode 903b of the second line.

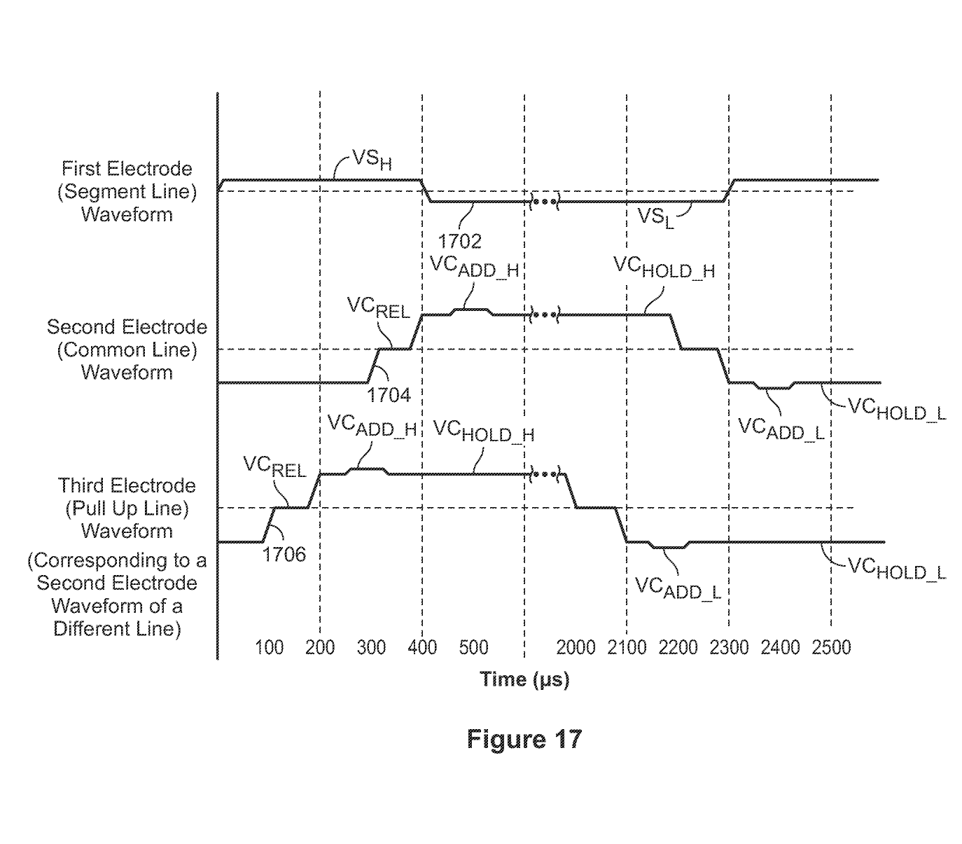

FIG. 17 is a diagram showing an example of voltage waveforms that may be applied to electrodes shown in FIG. 16. When writing display data to the array 30, lines may be written (i.e., voltage levels may be driven to each line) in a sequential order. Due to the electrical connection shown in FIG. 16, the waveform 1706 if applied to a second electrode 902a extending along a first line of display elements is simultaneously applied to the third electrode 903b extending along a second (different) line of display elements. Also shown in FIG. 17 is a voltage waveform 1702 applied to one of the first electrodes 901a, 901b, or 901c which is used to determine whether or not a corresponding display element 12 is selected to be actuated.

During a release period for the first line, the waveform 1706 applied on the second electrode 902a of the first line will be applied on the third electrode 903b of the second line just before the beginning of the release period of the second line. More specifically, as shown in FIG. 17, when the second electrode 902a of a first line is driven with VC_{REL} (shown by the third electrode waveform 1706), the third electrode 903b of the second line will be driven to VC_{REL}. This may happen while the second electrode waveform 1704 voltage applied to the second electrode 902b of the second line is still driven with VC_{HOLD}_{_{—}}_{L} (or VC_{HOLD}_{_{—}}_{H} depending on the current polarity) at the beginning of the release period of the second line. As the waveforms 1704 and 1706 will be different, a non-zero voltage difference (i.e., non-zero pull voltage) exists between the third electrode 903b and second electrode 902b of the second line during the release period of the second line. When the second electrode waveform 1704 voltage is then driven to VC_{REL}, the third electrode waveform 1706 voltage may be driven to VC_{HOLD}_{_{—}}_{H} (corresponding to the end of the first line release period when the second electrode 902 of the first line is driven with VC_{HOLD}_{_{—}}_{H}). This pattern repeats as the second electrode waveform 1704 will lag the third electrode waveform 1706. Note that the timing values are merely examples to show timing when applying each waveform sequentially to each line.

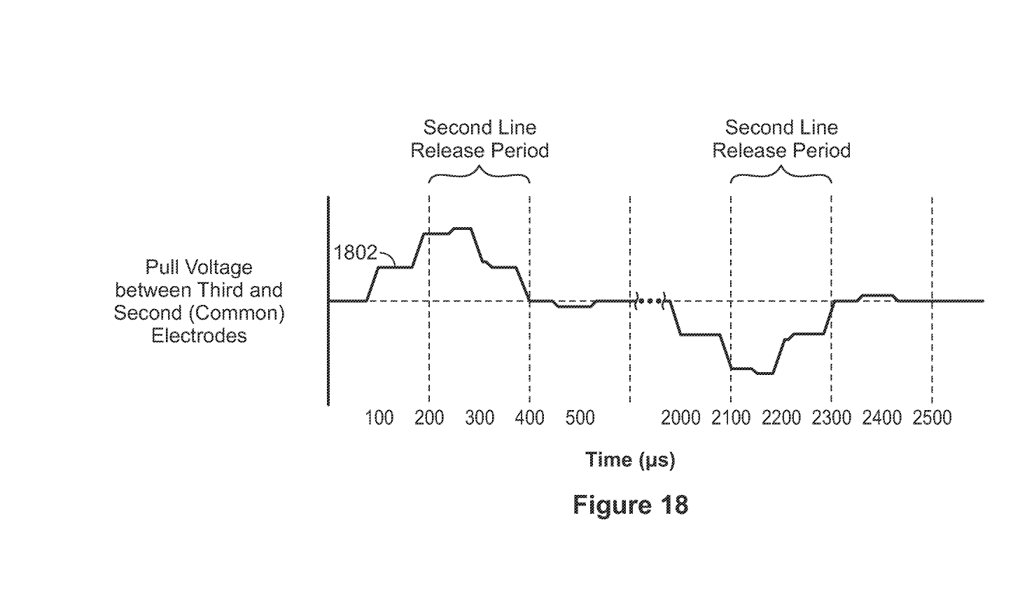

FIG. 18 is a diagram showing an example of the pull voltage 1802 between electrodes 902 and 903 of an interferometric modulator 12 based on the waveforms applied in FIG. 17. As shown, a non-zero pull voltage 1802 exists between the second and third electrodes 902 and 903 during the second line release period that may counteract the adhesion force. In addition, a non-zero pull voltage 1802 is also applied outside of the release period. This non-zero pull voltage corresponds to periods when the voltage level driven to the second electrode 902 of the first line does not match the voltage driven to second electrode 902 of the second line outside the release period. The effects of the non-zero pull voltage 1802 prior to the release period may not significantly impact the drive scheme if all pixels on the line are cleared during a release period in nominal operation.

Per the implementation described with reference to FIGS. 16-18, very little additional driver circuitry may be needed as a common driver output may be coupled to both the third electrode 903 of a given line of display elements and the second electrode 902 of a previous line of display elements. As described above, this may be accomplished in one aspect via an electrical connection between the third electrode of 903 of the second line and the second electrode 902 of the first line. This may be done for all the desired lines in the display. As such, the row driver circuit 24 may apply waveform voltages without any modification to what may be done for writing display data. This may significantly reduce the complexity, circuitry, and other components used to drive the third electrode 903 to counteract adhesion forces.

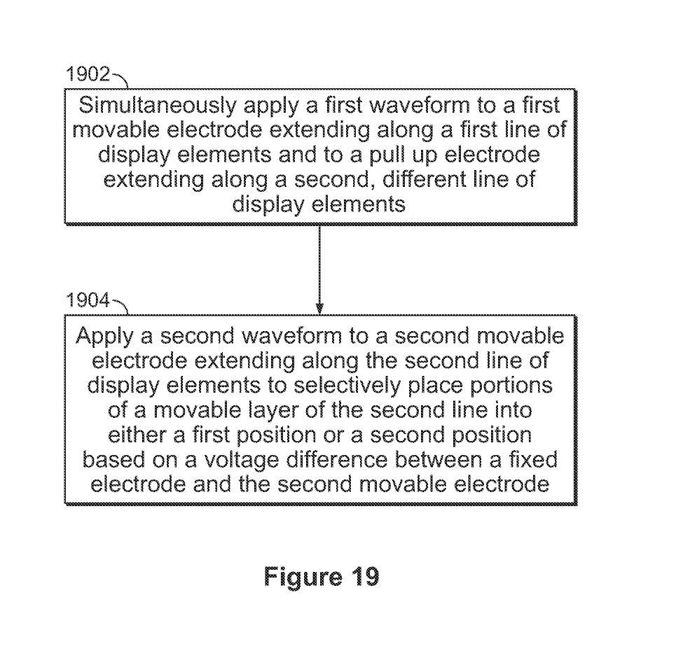

FIG. 19 is a flowchart of another example of a method of applying voltage levels to an array of interferometric modulators. The method of FIG. 19 may be used in conjunction with the implementation described above with reference to FIGS. 16 and 18. In block 1902, an array driver 22 may simultaneously apply a first waveform to a first movable electrode (i.e., a second electrode 902) extending along a first line of display elements (e.g., IMOD pixels) and to a “pull up” electrode (i.e., a third electrode 903) extending along a second, different line of display elements. The first movable electrode may be electrically connected to the pull up electrode. In block 1904, the array driver 22 may apply a second waveform to a second movable electrode extending along the second line of display elements to selectively place portions of a movable layer of the second line into either a first position or a second position based on a voltage difference between a fixed electrode (e.g., a first electrode 901) and the second movable electrode. As a release period of the first line may occur just before the release period of the second line, a non-zero pull voltage may exist between the second and third electrodes 902 and 903 of the second line during the release period of the second line as described above. The non-zero voltage may help ensure that the movable reflective layer 14 is released and is not in contact with the interface 913 of the IMOD display element 12. While a non-zero pull voltage may result between the second electrode 902 and the third electrode 903 during periods other than the release period, the effect on actuation may be negligible. As described above, this may allow for simplifying the components and complexity of the array driver 22 as additional drivers may not be needed to provide voltage levels to the pull up electrode 903.

The implementations described with reference to FIGS. 10-18 are shown with reference to a monochrome IMOD pixels. Similar method and techniques may be applied to driving an array of IMOD pixels having lines of different colors. For example, according to the implementation described with reference to FIGS. 16-18, the third electrode 903 may be electrically connected to a first previously driven line of IMOD pixels of the same color and polarity. This may help to ensure the voltages driven to the second electrode 902 of the previous line and the current line are matched appropriately.

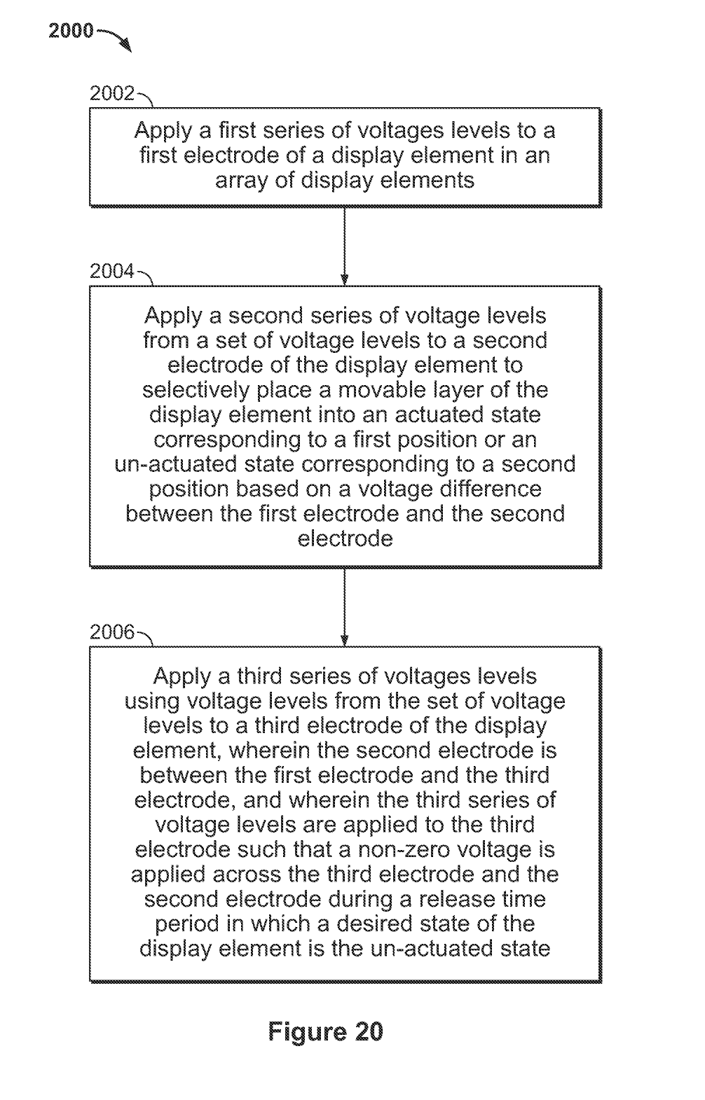

FIG. 20 is a flowchart of another example of a method of applying voltage levels to an array of interferometric modulators. In block 2002, an array driver 22 may apply a first series of voltages (i.e., a first waveform) to a first electrode 901 of a display element 12 in an array 30 of display elements. The first electrode 901 may correspond to a column electrode as described above. In block 2004, an array driver 22 may apply a second series of voltage levels (i.e., a second waveform) from a set of voltage levels to a second electrode of the display element to selectively place a movable layer (e.g., the movable reflective layer 14) of the display element into an actuated state corresponding to a first position or an un-actuated state corresponding to a second position based on a voltage difference between the first electrode 901 and the second electrode 902. The second electrode 902 may correspond to a row electrode as described above. The movable layer may include the second electrode 902. The number of voltage levels in the set may be fixed (e.g., by the capabilities of the hardware). The set of voltage levels may correspond to the five voltage levels (e.g., VC_{REL}, VC_{HOLD}_{_{—}}_{H}, VC_{HOLD}_{_{—}}_{L}, VC_{ADD} _{_{—}}_{H}, VC_{ADD} _{_{—}}_{L}) described above with reference to FIG. 4 for writing display data to individual display elements.

In block 2006, the array driver 22 may apply a third series of voltages levels (i.e., a third waveform) using voltage levels from the set of voltage levels to a third electrode 903 of the display element. The third series of voltage levels may include only those voltage levels from the set of voltage levels. The second electrode 902 may be between the first electrode 901 and the third electrode 903. The third series of voltage levels may be applied to the third electrode 903 such that a non-zero voltage (i.e., a non-zero pull voltage) exists between the third electrode 903 and the second electrode 902 during a release time period in which a desired state of the display element is the un-actuated state. This non-zero voltage may be applied to at least partially reduce or counteract an adhesion force generated between the movable layer and a first layer including the first electrode.

In some implementations, the third series of voltages levels may be substantially equal to the second series of voltages during an addressing time period that is different than the release time period. This may minimize any voltage between the third electrode 902 and second electrode 902 during the addressing time period so as not to interfere with actuation of a display element. The third series of voltage levels may include a smaller subset of voltage levels of the set of voltage levels (e.g., only VC_{HOLD} _{_{—}}_{H}, and VC_{HOLD}_{_{—}}_{L}) as described above with reference to FIGS. 13 and 14. The display element may be included in a first line of display elements in the array where the second and third electrodes 902 and 903 are shared by each of the display elements in the first line. The third series of voltages levels may also correspond to voltage levels applied to a fourth electrode in a second line of the array. The fourth electrode may correspond to the same type of electrode as the second electrode 902 of the first line. The voltage levels applied to the fourth electrode and the third electrode may be applied prior to applying the second series of voltage levels to the second electrode as described above with reference to FIGS. 16-18.

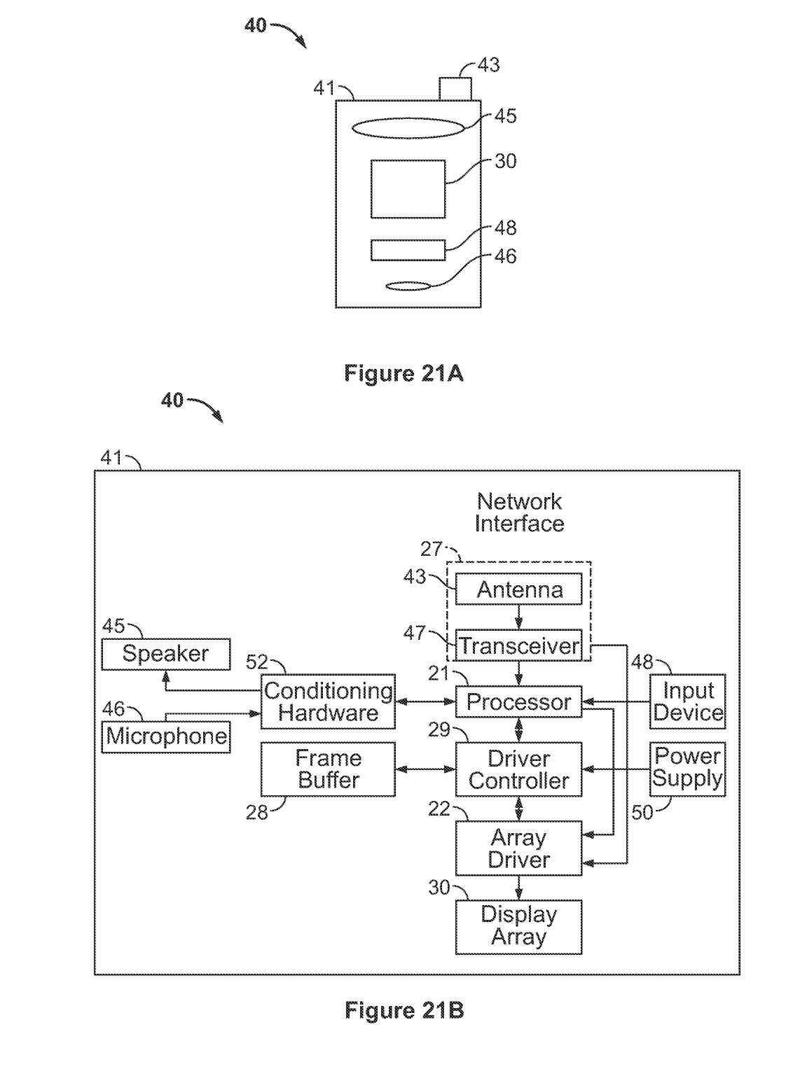

FIGS. 21A and 21B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 21B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for driving a display element in an array of display elements, the method comprising:
applying a first series of voltages to a first electrode of the display element;
applying a second series of voltages from a set of voltage levels to a second electrode of the display element to selectively place a movable layer of the display element into an actuated state corresponding to a first position or an un-actuated state corresponding to a second position based on a voltage difference between the first electrode and the second electrode; and
applying a third series of voltages levels using voltage levels from the set of voltage levels to a third electrode of the display element, wherein the second electrode is between the first electrode and the third electrode, and wherein the third series of voltage levels are applied to the third electrode such that a non-zero voltage exists between the third electrode and the second electrode during a release time period in which a desired state of the display element is the un-actuated state.

2. The method of claim 1, wherein the release time period is before an addressing period during which the display element is selectively placed into an actuated state or left in an un-actuated state.

3. The method of claim 1, wherein applying the second series of voltage levels includes applying the second series of voltage levels during an addressing time period, and wherein the third series of voltages are substantially equal to the second series of voltages during the addressing time period.

4. The method of claim 1, wherein applying the second series of voltage levels includes applying the second series of voltage levels during an addressing time period, and wherein the third series of voltage levels correspond to a subset of the set of voltage levels during the addressing time period, the subset including a fewer number of voltage levels than a total number of voltage levels in the set of voltage levels.

5. The method of claim 1, wherein applying the second series of voltage levels includes applying the second series of voltage levels during an addressing time period, and wherein the third series of voltage are determined such that substantially zero voltage exists between the third electrode and the second electrode during the addressing time period.

6. The method of claim 1, wherein the display element is included in a first line of display elements in the array of display elements, wherein the second and third electrodes extend along the first line of display elements, and wherein the third series of voltages correspond to voltage levels simultaneously applied to a fourth electrode extending along a second line of display elements of the array of display elements.

7. The method of claim 6, wherein the voltage levels applied to the fourth electrode and the third electrode are applied prior to applying the second series of voltages to the second electrode.

8. The method of claim 1, wherein an adhesion force is generated between the movable layer and a first layer including the first electrode when the display element is in an actuated state, and wherein the non-zero voltage during the release time period is applied to at least partially reduce or counteract the adhesion force.

9. The method of claim 1, wherein the second and third electrodes are shared by each display element in a line of display elements of the array of display elements.

10. The method of claim 1, wherein the movable layer includes the second electrode.

11. The method of claim 1, wherein the display element includes an electromechanical system device including an interferometric modulator.

12. The method of claim 1, wherein a total number of voltage levels in the set of voltage levels is based on a capability of one or more voltage driver circuits configured to provide a fixed number of voltage levels.

13. The method of claim 1, wherein the display element is a bi-stable display element having two states including the actuated state and the un-actuated state.

14. An apparatus for driving a display device comprising:
a display element included in an array of display elements, the display element including:
a first electrode;
a second electrode;
a third electrode, wherein the second electrode is located between the first electrode and the third electrode; and
a movable layer configured to be in an actuated state in a first position or an un-actuated state in a second position based on a voltage difference between the first electrode and the second electrode; and
a driver circuit configured to:
apply a first series of voltage levels to the first electrode;
apply a second series of voltage levels from a set of voltage levels to the second electrode, wherein the first series and second series of voltages levels are applied to selectively place the display element into the actuated or the un-actuated state; and
apply a third series of voltages levels using voltage levels from the set of voltage levels to the third electrode of the display element, wherein the third series of voltage levels are applied to the third electrode such that a non-zero voltage exists between the second electrode and the third electrode during a release time period in which a desired state of the display element is the un-actuated state.

15. The apparatus of claim 14, wherein the release time period is before an addressing period during which the display element is selectively placed into an actuated state or left in an un-actuated state.

16. The apparatus of claim 14, wherein the driver circuit is configured to apply the second series of voltage levels during an addressing time period, and wherein the third series of voltage levels are substantially equal to the second series of voltages levels during the addressing time period.

17. The apparatus of claim 14, wherein the driver circuit is configured to apply the second series of voltage levels during an addressing time period, and wherein the third series of voltage levels correspond to a subset of the set of voltage levels during the addressing time period, the subset including a fewer number of voltage levels than a total number of voltage levels in the set of voltage levels.

18. The apparatus of claim 14, wherein the driver circuit is configured to apply the second series of voltage levels during an addressing time period, and wherein the third series of voltage are determined such that substantially zero voltage exists between the third electrode and the second electrode during the addressing time period.

19. The apparatus of claim 14, wherein the display element is included in a first line of display elements in the array of display elements, wherein the second and third electrodes extend along the first line of display elements, and wherein the third series of voltages correspond to voltage levels simultaneously applied to a fourth electrode extending along a second line of display elements of the array of display elements.

20. The apparatus of claim 19, wherein the driver circuit is configured to apply voltage levels to the fourth electrode and the third electrode prior to applying the second series of voltages to the second electrode.

21. The apparatus of claim 14, wherein an adhesion force is generated between the movable layer and a first layer including the first electrode when the display element is in an actuated state, and wherein the non-zero voltage during the release time period is applied to at least partially reduce or counteract the adhesion force.

22. The apparatus of claim 14, wherein the second and third electrodes are shared by each display element in a line of display elements of the array of display elements.

23. The apparatus of claim 14, wherein the movable layer includes the second electrode.

24. The apparatus of claim 14, wherein the display element is a bi-stable display element having two states including the actuated state and the un-actuated state.

25. The apparatus of claim 14, wherein the display element includes an electromechanical system device including an interferometric modulator.

26. The apparatus of claim 14, further comprising:
a display;
a processor that is configured to communicate with the display, the processor being configured to process image data; and
a memory device that is configured to communicate with the processor.

27. The apparatus as recited in claim 26, wherein the driver circuit is configured to send at least one signal to the display.

28. The apparatus as recited in claim 27, further comprising:
a controller configured to send at least a portion of the image data to the driver circuit.

29. The apparatus as recited in claim 26, further comprising:
an image source module configured to send the image data to the processor.

30. The apparatus as recited in claim 29, wherein the image source module includes at least one of a receiver, transceiver, and transmitter.

31. The apparatus as recited in claim 26, further comprising:
an input device configured to receive input data and to communicate the input data to the processor

32. An apparatus for driving a means for displaying in an array of means for displaying, the apparatus comprising:
means for applying a first series of voltages to a first means for conducting of the means for displaying;
means for applying a second series of voltages from a set of voltage levels to a second means for conducting of the means for displaying to selectively place a movable layer of the means for displaying into an actuated state corresponding to a first position or an un-actuated state corresponding to a second position based on a voltage difference between the first means for conducting and the second means for conducting; and
means for applying a third series of voltages levels using voltage levels from the set of voltage levels to a third means for conducting of the means for displaying, wherein the second means for conducting is between the first means for conducting and the third means for conducting, and wherein the third series of voltage levels are applied to the third means for conducting such that a non-zero voltage exists between the third means for conducting and the second means for conducting during a release time period in which a desired state of the means for displaying is the un-actuated state.

33. The apparatus of claim 32, wherein the release time period is before an addressing period during which the means for displaying is selectively placed into an actuated state or left in an un-actuated state.

34. The apparatus of claim 32, wherein the means for applying the second series of voltage levels is configured to apply the second series of voltage levels during an addressing time period, and wherein the third series of voltages are substantially equal to the second series of voltages during the addressing time period.

35. The apparatus of claim 32, wherein the means for applying the second series of voltage levels is configured to apply the second series of voltage levels during an addressing time period, and wherein the third series of voltage levels correspond to a subset of the set of voltage levels during the addressing time period, the subset including a fewer number of voltage levels than a total number of voltage levels in the set of voltage levels.

36. The apparatus of claim 32, wherein the means for applying the second series of voltage levels is configured to apply the second series of voltage levels during an addressing time period, and wherein the third series of voltage are determined such that substantially zero voltage exists between the third means for conducting and the second means for conducting during the addressing time period.

37. The apparatus of claim 32, wherein the means for displaying is included in a first line of means for displaying in the array of means for displaying, wherein the second and third means for conducting extend along the first line of means for displaying, and wherein the third series of voltages correspond to voltage levels simultaneously applied to a fourth means for conducting extending along a second line of means for displaying of the array of means for displaying.

38. The apparatus of claim 37, wherein the voltage levels applied to the fourth means for conducting and the third means for conducting are applied prior to applying the second series of voltages to the second means for conducting.

39. The apparatus of claim 32, wherein an adhesion force is generated between the movable layer and a first layer including the first means for conducting when the means for displaying is in an actuated state, and wherein the non-zero voltage during the release time period is applied to at least partially reduce or counteract the adhesion force.

40. The apparatus of claim 32, wherein the means for displaying is a bi-stable display element having two states including an actuated state and an un-actuated state.

41. The apparatus of claim 32, wherein the means for displaying includes a display element.

42. The apparatus of claim 32, wherein the means for displaying includes an electromechanical system device including an interferometric modulator.

43. The apparatus of claim 32, wherein the first means for conducting, the second means for conducting, and the third means for conducting include electrodes.

44. The apparatus of claim 32, wherein the means for applying a first series of voltages, the means for applying a second series of voltages, and the means for applying a third series of voltages includes a driver circuit.

45. A computer program product, comprising:
computer-readable medium comprising:
code for applying a first series of voltages to a first electrode of a display element;
code for applying a second series of voltages from a set of voltage levels to a second electrode of the display element to selectively place a movable layer of the display element into an actuated state corresponding to a first position or an un-actuated state corresponding to a second position based on a voltage difference between the first electrode and the second electrode; and
code for applying a third series of voltages levels using voltage levels from the set of voltage levels to a third electrode of the display element, wherein the second electrode is between the first electrode and the third electrode, and wherein the third series of voltage levels are applied to the third electrode such that a non-zero voltage exists between the third electrode and the second electrode during a release time period in which a desired state of the display element is the un-actuated state.

46. The computer program product of claim 45, wherein the release time period is before an addressing period during which the display element is selectively placed into an actuated state or left in an un-actuated state.

47. The computer program product of claim 45, wherein the code for applying the second series of voltage levels includes code for applying the second series of voltage levels during an addressing time period, and wherein the third series of voltages are substantially equal to the second series of voltages during the addressing time period.

48. The computer program product of claim 45, wherein the code for applying the second series of voltage levels includes code for applying the second series of voltage levels during an addressing time period, and wherein the third series of voltage levels correspond to a subset of the set of voltage levels during the addressing time period, the subset including a fewer number of voltage levels than a total number of voltage levels in the set of voltage levels.

49. The computer program product of claim 45, wherein the code for applying the second series of voltage levels includes code for applying the second series of voltage levels during an addressing time period, and wherein the third series of voltage are determined such that substantially zero voltage exists between the third electrode and the second electrode during the addressing time period.

50. The computer program product of claim 45, wherein the display element is included in a first line of display elements in the array of display elements, wherein the second and third electrodes extend along the first line of display elements, and wherein the third series of voltages correspond to voltage levels simultaneously applied to a fourth electrode extending along a second line of display elements of the array of display elements.

51. The computer program product of claim 50, wherein the voltage levels applied to the fourth electrode and the third electrode are applied prior to applying the second series of voltages to the second electrode.

52. The computer program product of claim 45, wherein an adhesion force is generated between the movable layer and a first layer including the first electrode when the display element is in an actuated state, and wherein the non-zero voltage during the release time period is applied to at least partially reduce or counteract the adhesion force.

53. The computer program product of claim 45, wherein the display element includes an electromechanical system device including an interferometric modulator.

54. The computer program product of claim 45, wherein the display element is a bi-stable display element having two states including the actuated state and the un-actuated state.

55. A method for driving a display element in an array of display elements, the method comprising:
simultaneously applying a first waveform to a first movable electrode extending along a line of display elements and to a pull up electrode extending along a different line of display elements; and
applying a second waveform to a second movable electrode extending along the different line of display elements to selectively place portions of a movable layer of the different line into either a first position or a second position based on a voltage difference between a fixed electrode and the second movable electrode.

56. The method of claim 55, wherein an adhesion force is generated between the movable layer and a fixed layer including the fixed electrode, and wherein the second waveform produces a non-zero voltage during a release time period to at least partially reduce or counteract the adhesion force.

57. An apparatus for driving a display device comprising:
a driver circuit; and
a line of display elements in an array of display elements, the line of display elements including:
a first movable electrode extending along the line of display elements; and
a pull up electrode extending along the line of display elements, wherein the pull up electrode and a second movable electrode of a different line of display elements in the array of display elements are coupled to a common output of the driver circuit.

58. The apparatus of claim 57, wherein the pull up electrode is directly electrically connected to the second movable electrode of the different line of display elements in the array of display elements such that the same waveform is simultaneously applied to the pull up electrode and to the second movable electrode of the different line of display elements.
